(19) United States
(12) Patent Application Publication
(10) Pub. No.: US 2022/0287232 A1
(43) Pub. Date: Sep. 15, 2022

(54) Trimmer String Holder

(71) Applicant: Cuddeback Machining, Inc., Hilton, NY (US)

(72) Inventor: Paul L. Cuddeback, Brockport, NY (US)

(73) Assignee: Cuddeback Machining, Inc., Hilton, NY (US)

(21) Appl. No.: 17/691,234

(22) Filed: Mar. 10, 2022

Related U.S. Application Data
(60) Provisional application No. 63/161,083, filed on Mar. 15, 2021.

(51) Int. Cl. A01D 34/416

(52) U.S. Cl. CPC A01D 34/4166

(57) ABSTRACT

Spare trimmer string can be stored in a trimmer string holder mounted on a trimmer pole via cooperating between a pole nest on the holder and a clamp on opposed sides of the pole. The pole nest supports a hub having spars supporting an annular channel and includes a recess that can include mechanical features to enhance mounting. The holder can be formed from two identical halves, each including respective portions of opposed spars, one respective portion having a projection and the other a recess so that the projection of one is received in the recess of the other.

### BACKGROUND

The invention relates generally to carriers or holders for replacement string or line for trimmers used in lawn care, and the like. More specifically, the invention relates to such a holder for spare or replacement string that attaches to the trimmer for which the string is intended.

While some prior art holders for spare trimmer string exist, they generally either store very short lengths of string in a tubular enclosure or are holders for extra spools of string. A holder for lengths between short lengths and full replacement spools is desirable.

### SUMMARY

An embodiment of the invention disclosed herein may include an annular wall having a front lip at one edge thereof and a back lip at an opposed edge thereof, together forming an annular channel. A hub within a perimeter of the annular wall can include at least one spar extending from the hub to the back lip, connecting the hub to and supporting the annular wall. The trimmer string holder can also include a pole nest on a back of the hub and a clamp, whereby when the pole nest and the clamp are on opposite sides of a trimmer pole, screws inserted through holes in the clamp and the pole nest move the clamp and the pole nest toward each other and the pole until the clamp and the pole nest squeeze the pole, thereby securing the pole nest and the trimmer string holder to the pole.

Another embodiment of the invention disclosed herein may include a a pole nest configured for mounting on a trimmer pole and a hub having a front and a back, the hub being attached to the pole nest on the back of the hub. An annular channel of the trimmer string holder can be configured to receive trimmer string, and at least one spar can extend from the hub to the annular channel, thereby supporting the annular channel. The trimmer string holder can include a clamp, and when the pole nest and the clamp are on opposite sides of a trimmer pole, screws inserted through holes in the clamp and the pole nest can move the clamp and the pole nest toward each other and the pole until the clamp and the pole nest squeeze the pole, thereby securing the pole nest and the trimmer string holder to the pole.

A method of assembling a trimmer string holder according to embodiments disclosed herein can include forming substantially identical halves, each half including respective portions of an annular wall, respective portions of a hub, and respective portions of opposed spars. The method can further include arranging the substantially identical halves so that respective edges of the halves face each other and attaching the so arranged halves to a pole nest, thereby forming the trimmer string holder.

Additional features and advantages are realized through the techniques of the present invention. Other embodiments and aspects of the invention are described in detail herein and are considered a part of the claimed invention. For a better understanding of the invention with the advantages and the features, refer to the description and to the drawings.

### BRIEF DESCRIPTION OF THE SEVERAL VIEWS OF THE DRAWINGS

The subject matter which is regarded as the invention is particularly pointed out and distinctly claimed in the claims at the conclusion of the specification. The foregoing and other features and advantages of the invention are apparent from the following detailed description taken in conjunction with the accompanying drawings.

FIG. 1 is an elevation of a front of an example of a trimmer string holder according to embodiments of the invention disclosed herein mounted on a trimmer pole.

FIG. 2 is an elevation of a back of an example of a trimmer string holder according to embodiments of the invention disclosed herein mounted on a trimmer pole.

FIG. 3 is an elevation of a front of an example of a trimmer string holder according to embodiments of the invention disclosed herein.

FIG. 4 is an elevation of a back of an example of a trimmer string holder according to embodiments of the invention disclosed herein.

FIG. 5 is an exploded view of a trimmer string holder according to embodiments of the invention disclosed herein.

FIG. 6 is an elevation of a front of a second example of a trimmer string holder according to embodiments of the invention disclosed herein mounted on a trimmer pole.

FIG. 7 is an elevation of a back of a second example of a trimmer string holder according to embodiments of the invention disclosed herein mounted on a trimmer pole.

FIG. 8 is an elevation of a front of a second example of a trimmer string holder according to embodiments of the invention disclosed herein.

FIG. 9 is an elevation of a back of a second example of a trimmer string holder according to embodiments of the invention disclosed herein.

FIG. 10 is an exploded view of a second example of a trimmer string holder according to embodiments of the invention disclosed herein.

### DETAILED DESCRIPTION

Embodiments of the present invention are directed to a trimmer string holder that mounts on a string trimmer, such as on a pole thereof. Replacement lengths of trimmer string can be carried conveniently on the trimmer thereby. In embodiments, the replacement lengths can take the form of loops and/or coils resting in the trimmer string holder as will be described below.

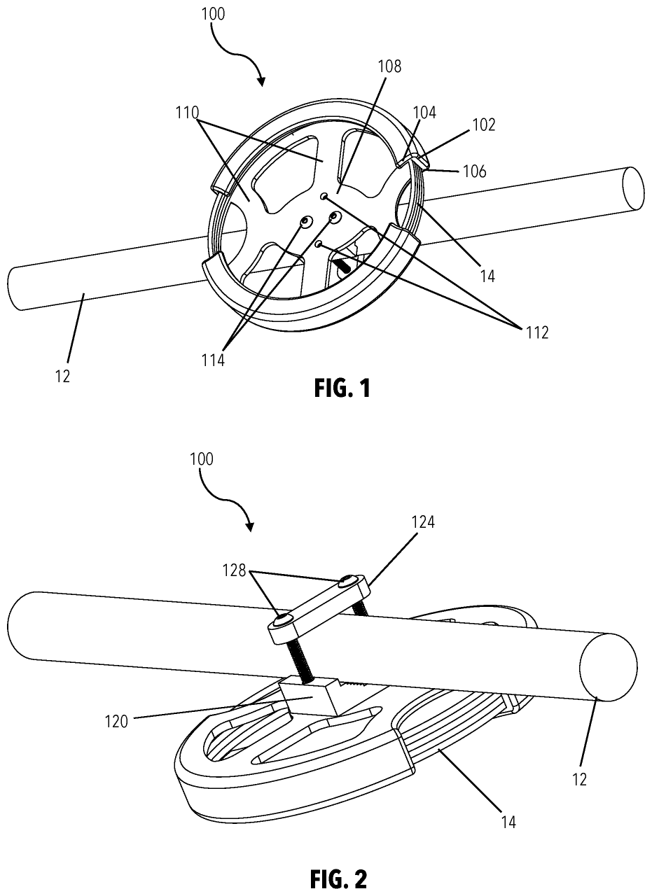

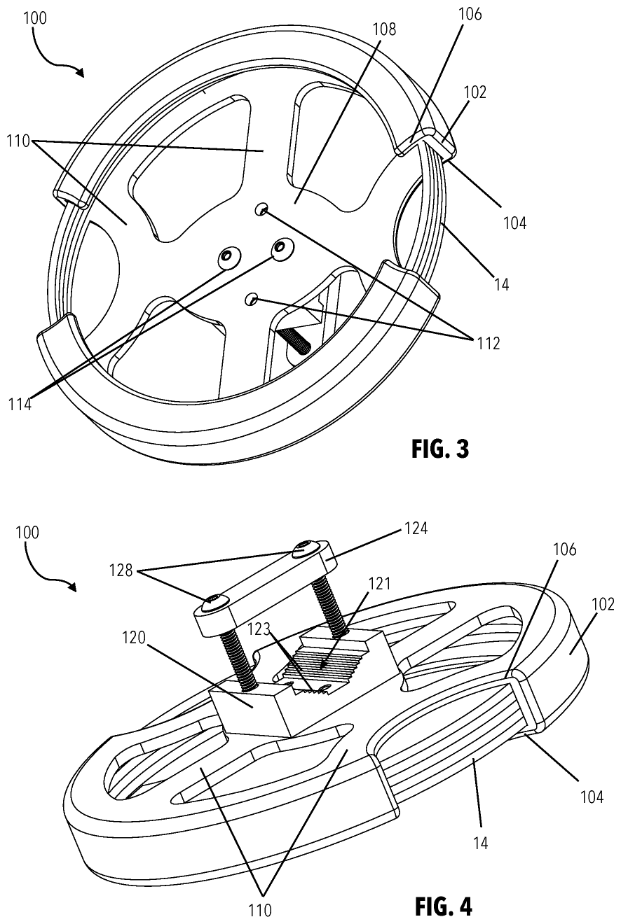

More particularly, with reference to FIGS. 1-5, a trimmer string holder 100 according to embodiments can include an annular wall 102 with a front lip 104 at one edge of annular wall 102 and a back wall or back lip 106 at an opposed edge of annular wall 102. Together, annular wall 102, front lip 104, and back wall/lip 106 can form an annular channel, such as with a U-shaped cross section, that can store spare trimmer string, such as loops or coils thereof. Neither front lip 104 nor back wall or back lip 106 need be continuous so long as together they form an annular channel that can support and/or retain spare trimmer string. Annular wall 102 is supported on a trimmer pole 12 via a hub 108 supported thereon and one or more spars 110 extending between hub 108 and back wall/lip 106. Hub 108 can be attached to pole 12 via a pole nest 120 on a back of hub 108 and on one side of pole 12, and a clamp 124 arranged on an opposite side of pole 12. Pole nest 120 can be formed as part of hub 108 in embodiments, while in other embodiments pole nest 120 can be a separately formed part attached to hub 108 by front screws 114 through corresponding ones of holes 112, 122 in hub 108 and pole nest 120, respectively. In embodiments, pole nest 120 can include a recess 121, which can include a surface shaped to better receive pole 12. Additionally, embodiments can include mechanical features 123 on a surface of recess 121 that will engage pole 12, such as teeth or ridges. Such mechanical features 123 can enhance attachment of holder 100 to pole 12.

Clamp 124 can be connected to pole nest 120 by back screws 128 extending through holes 126 in clamp 124, and corresponding ones of holes 122 in pole nest 120. In embodiments, back screws 128 can extend into corresponding ones of holes 112 in hub 108. Back screws 128 when tightened cause clamp 124 and pole nest 120 to move toward and squeeze pole 12, thereby securing trimmer string holder 100 in place on pole 12.

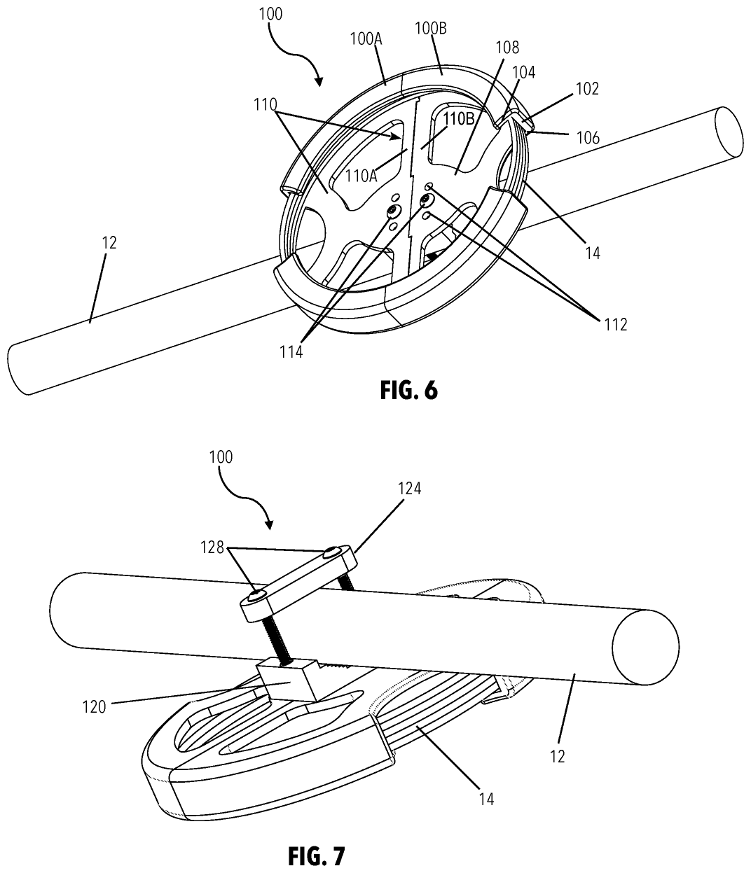

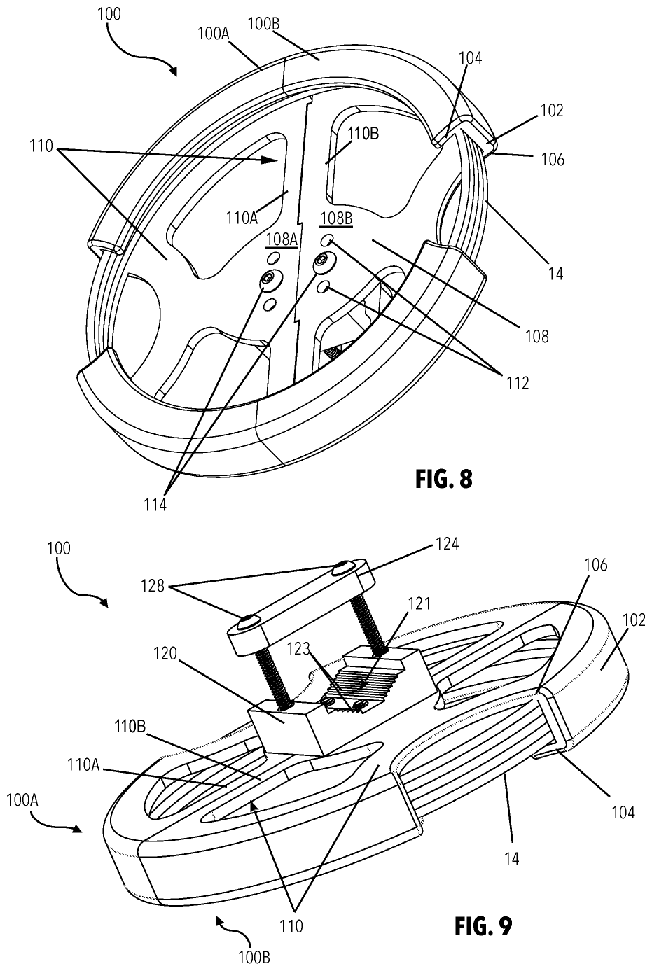

Another example of a trimmer string holder 100 according to embodiments of the invention disclosed herein is shown in FIGS. 6-10. Here, trimmer string holder 100 can include two substantially identical halves 100A, 100B, which can be advantageous for manufacturing and shipping, for example. Each half 100A, 100B can include portions of annular wall 102, front lip 104, and back wall/lip 106 that become properly arranged and oriented when the halves 100A, 100B are assembled. In addition, each half 100A, 100B can include respective portions 108A, 108B of hub 108, as well as respective portions 110A, 110B of one or more spars 110. It should be noted that each half 100A, 100B can also include one or more complete spars 110 in embodiments, and each half 100A, 100B includes respective holes 112 for receiving front screws 114 and, in embodiments, back screws 128 for assembly and mounting of halves 100A, 100B into trimmer string holder 100 on pole 12.

As with the first example of a trimmer string holder 100 according to embodiments described above, a pole nest 120 can hold assembled halves 100A, 100B on trimmer pole 12. As above, in embodiments, pole nest 120 can include a recess 121, which can include a surface shaped to better receive pole 12. Additionally, embodiments can include mechanical features 123 on a surface of recess 121 that can engage pole 12, such as teeth or ridges. Such mechanical features 123 can enhance attachment of holder 100 to pole 12.

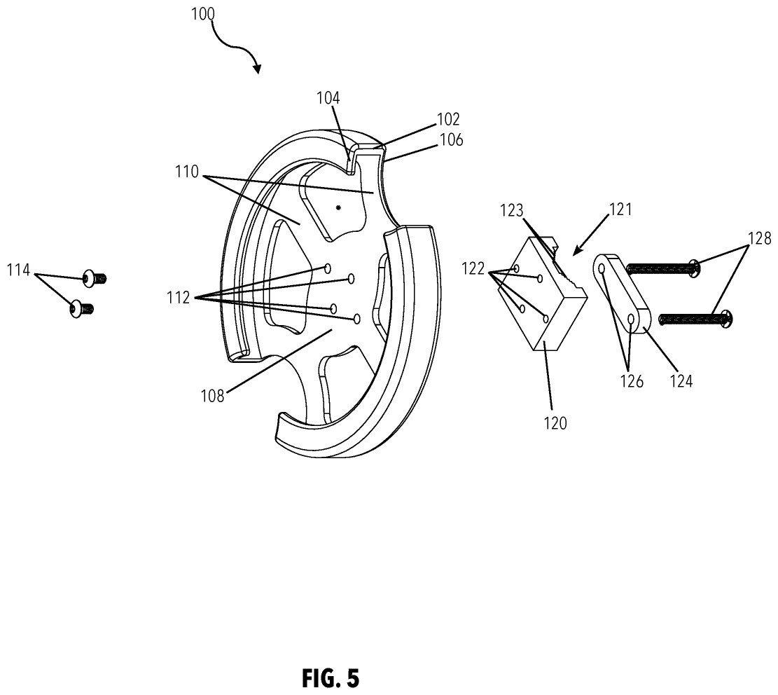

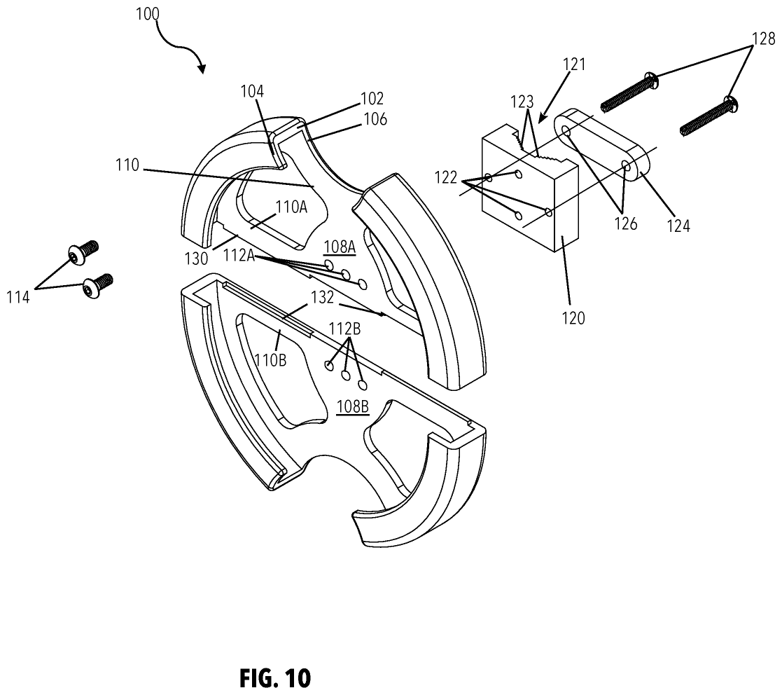

As seen particularly in FIG. 10, each half 100A, 100B of trimmer string holder 100 can include a projection 130 and a recess 132. For example, half 100A includes a projection 130 formed in one spar portion 110A and a recess 132 formed in an opposed spar portion 110A. Half 100B is substantially identical to half 100A, so that when edges of spar portions 110A, 110B face each other, a projection 130 of each half 100A, 100B will face a corresponding recess 132 of the other half 100A, 100B. By forming projection 130 and recess 132 to have corresponding and cooperating profiles, attachment of halves 100A, 100B to each other, to pole nest 120, and to pole 12 can be enhanced. It should be noted that while one projection 130 and one recess 132 are shown in FIG. 5, using two or more of each is within the scope of embodiments.

A method of assembly of the second example of trimmer string holder 100 can include forming substantially identical halves 100A, 100B with features as described above, arranging the halves so that a projection 130 of one extends into a recess 132 of the other, and attaching the so arranged halves to nest 120 with front screws 114. Assembled halves 100A, 100B and pole nest 120 can then be placed against one side of trimmer pole 12, such as with trimmer pole 12 resting against pole nest 120, while clamp 124 can be arranged on an opposite side of trimmer pole 12. Back screws 128 can then be inserted through clamp 124 and at least pole nest 120 via holes 126, 122. Holes 122 can include threads such that back screws 128 can be tightened to move clamp 124 and pole nest 120 toward pole 12 and to eventually squeeze pole 12, thereby securing trimmer string holder 100 on pole 12. In embodiments in which back screws 128 extend into holes 112 of hub 108, holes 112 can include threads in addition to or instead of holes 122 including threads.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

1. A torque limiting handle comprising:
a body including a head at one end, an axial bore at an opposite end and concentric with a longitudinal axis of the body, a compartment therebetween, and a cover mounted over the compartment;
a sprocket rotatably mounted in the head and including a plurality of teeth, the sprocket further including a one of a polygonal projection extending from a center of the sprocket and a polygonal socket in the center of the sprocket arranged to drivingly connect the handle to a corresponding one of a polygonal socket of another device and a polygonal projection of another device;
a detent extending from the compartment into the head and engaging at least one tooth of the sprocket;
a spring mounted between the detent and the axial bore at the opposite of the body, a plunger mounted between the spring and the axial bore of the body, and a set screw mounted in the body axial bore, the set screw engaging the plunger, the plunger engaging the spring, and the spring engaging the detent such that the spring exerts a biasing force on the detent, turning the set screw in one direction increases the biasing force, and turning the set screw in an opposite direction decreases the biasing force; and
a grip extending from the opposite end of the body and blocking access to the set screw.

2. (canceled)

3. The torque limiting handle of claim 2, wherein the one of a polygonal projection and a polygonal socket of the sprocket includes a polygonal projection and a biased ball detent in the polygonal projection, thereby providing resistance to removal from a corresponding polygonal socket of another device.

4. The torque limiting handle of claim 1, wherein the one of a polygonal projection and a polygonal socket of the sprocket includes a polygonal socket in a center of the sprocket arranged to drivingly connect the handle to a corresponding polygonal projection of another device.

5. (canceled)

6. The torque limiting handle of claim 1, further comprising a transverse bore having an axis perpendicular to a longitudinal axis of the body and crossing the axial bore of the body, and wherein the grip comprises a knob extending from a front of the transverse bore and rotatably supported in the transverse bore by a bearing mounted in the transverse bore, the knob and the bearing being secured in the transverse bore and thereby blocking access to the set screw.

7. The torque limiting handle of claim 1, wherein the grip comprises an extension mounted in the axial bore and projecting coaxially from the opposite end of the body, thereby blocking access to the set screw.

8. The torque limiting handle of claim 7, wherein the extension is secured to the end of the body by corresponding threads of the extension and of the axial bore at the opposite end of the body.

9. A torque limiting handle comprising:
a body including a head at one end, an axial bore at an opposite end that is concentric with a longitudinal axis of the body, a compartment between the head and the axial bore, and a cover mounted over the compartment;
a sprocket rotatably mounted in the head and including a plurality of teeth, the sprocket further including one of a polygonal projection and a polygonal socket arranged to drivingly connect the handle to a corresponding one of a polygonal socket and a polygonal projection of another device;
a detent mounted in and extending from the compartment into the head and engaging at least one tooth of the sprocket;
a spring mounted in the compartment between the detent and the axial bore of the body, a plunger mounted in the compartment between the spring and the axial bore of the body, and a set screw mounted in the axial bore of the body, the set screw engaging the plunger, the plunger engaging the spring, and the spring engaging the detent such that the spring exerts a biasing force on the detent, turning the set screw in one direction increases the biasing force, and turning the set screw in an opposite direction decreases the biasing force; and
a grip extending from the opposite end of the body and blocking access to the set screw.

10. (canceled)

11. The torque limiting handle of claim 9, wherein the one of a polygonal projection and a polygonal socket includes a polygonal socket in a center of the sprocket.

12. The torque limiting handle of claim 9, wherein the body further includes a transverse bore at the opposite end of the body having an axis perpendicular to the longitudinal axis of the body and crossing the axial bore of the body, and wherein the grip comprises a knob extending from a front of the transverse bore and rotatably supported in the transverse bore by a bearing mounted in the transverse bore, the knob and the bearing being secured in the transverse bore.

13. The torque limiting handle of claim 12, wherein the bearing is a bushing.

14. The torque limiting handle of claim 9, wherein the grip comprises an extension mounted in the axial bore and projecting coaxially from the opposite end of the body, thereby blocking access to the set screw.

15. The torque limiting handle of claim 14, wherein the extension is secured to the end of the body by corresponding threads of the extension and of the axial bore at the opposite end of the body.

16. A method of limiting torque to be applied to a rotatable element by a torque limiting handle that comprises:
a body including a head at one end, an axial bore at an opposite end that is concentric with a longitudinal axis of the body, a compartment therebetween, and a cover mounted over the compartment;
a sprocket rotatably mounted in the head and including a plurality of teeth, the sprocket further including one of a polygonal projection and a polygonal socket arranged to drivingly connect the handle to a corresponding one of a polygonal projection and a polygonal socket of another device;
a detent extending from the compartment into the head and engaging at least one tooth of the sprocket;
a spring mounted between the detent and the axial bore of the body, a plunger mounted between the spring and the axial bore of the body, and a set screw mounted in the body between the compartment and the axial bore, the set screw engaging the plunger, the plunger engaging the spring, and the spring engaging the detent such that the spring exerts a biasing force on the detent, turning the set screw in one direction increases the biasing force, and turning the set screw in an opposite direction decreases the biasing force; and
a grip that extends from the opposite end of the body when installed in the torque limiting handle;
the method comprising:
forming the one of a polygonal socket and a polygonal projection;
determining a desired maximum torque to be applied to the rotatable element;
turning the set screw to adjust the biasing force to a value corresponding to the desired maximum torque that will be applied; and
blocking access to the set screw by installing the grip.

17. The method of claim 16, further comprising a transverse bore at the opposite end of the body having an axis perpendicular to a longitudinal axis of the body and crossing the axial bore, and wherein blocking access to the set screw includes:
mounting a bearing in the transverse bore;
inserting a knob into the bearing in the transverse bore such that the knob extends from a front of the transverse bore and is rotatably supported in the transverse bore by the bearing mounted in the transverse bore; and
securing the knob and the bearing in the transverse bore, thereby blocking access to the set screw.

18. The method of claim 16, wherein blocking access to the set screw includes connecting an extension to the axial bore at the opposite end of the body and such that the extension projects coaxially with a longitudinal axis of the body.

19. The method of claim 18, wherein the torque limiting handle further comprises corresponding threads of the extension and the axial bore at the opposite end of the body and connecting the extension includes screwing the extension and the body together.

20. (canceled)
